(19) United States
(12) Patent Application Publication
(10) Pub. No.: US 2006/0152039 A1
(43) Pub. Date: Jul. 13, 2006

(54) Vehicle architecture

(76) Inventor: Kris Tomasson, Corona del Ma, CA (US)

Correspondence Address: BROOKS KUSHMAN P.C./FGTL, 1000 TOWN CENTER, 22ND FLOOR, SOUTHFIELD, MI, 48075-1238, US

(21) Appl. No.: 11/031,893

(22) Filed: Jan. 7, 2005

(51) Int. Cl. B60R 13/00

(52) U.S. Cl. 296/180.2

(57) ABSTRACT

One aspect of the present invention is vehicle architecture including a vehicle exterior. The vehicle exterior includes a front end having front end design cues and a rear end having rear end design cues. One of the front and rear end design cues has commonality to produce a common design cue to reinforce the brand identify of the vehicle.

### BACKGROUND OF THE INVENTION

1. Field of the Invention

One aspect of the present invention generally relates to a vehicle design architecture, and more specifically, to a vehicle exterior design architecture.

2. Background Art

In the automotive industry, brand recognition is an important factor in a vehicle's marketing mix. Vehicle manufacturers often expend vast resources targeted at the design of appealing vehicle exteriors to enhance their brand's recognition in the marketplace.

Often, design cues are built into exterior vehicle surfaces and components. Several prior art proposals exemplify the use of design cues on the exterior of vehicles. Although these proposals are geared at enhancing brand recognition, the proposals have had varying levels of success. One reason is that the design cues are often unlinked to an overall design theme for the exterior of the vehicle, thereby not presenting a robust or memorable design to the consumer.

For example, FIGS. 1a, 1b, and 1c depict different views of the 2005 GMC Safari Minivan. According to FIG. 1a, the front end of the GMC Safari includes a stylized bumper having two horizontal lines wherein the lower line is broken into two segments to afford an area to mount a license plate. The front of the vehicle also has a grill with several parallel horizontal slats, thereby producing a vented design. The headlights are broken into three rectangular compartments, thus producing a set of squared-off design lines.

According to FIG. 1b, the rear of the GMC Safari includes a bumper having a single horizontal line located lengthwise along the middle area of the bumper. The vehicle rear also includes a pair of taillights having a polygonal shape with a long subtlely curved side. By way of comparison, the design cues used on the front and rear of the GMC Safari are not linked to a general design theme.

Moreover, the side view of the GMC Safari, as depicted in FIG. 1c, shows that the edge lines of the vehicle front and rear ends have different contours. With respect to the front of the vehicle, from the belt line to the platform line, the edge contour includes a vertical segment connected to a bumper outline. The bumper outline outwardly tapers from the lower of the vertical style line, then drops vertically and then inwardly tapers. The rear of the vehicle has a vertically downward extending portion that extends from the belt line to the bumper. The bumper extends in a horizontal outwardly direction from the lower of the vertically extending line, then tapers inwardly to meet a horizontal line segment. In sum, the front and rear end edge contours are unlinked, and do not portray a common design that is suitable for reinforcing the brand identity of the vehicle.

Another example of a vehicle having unlinked design cues is the 2005 Toyota Sienna as shown in FIGS. 2a, 2b, and 2c. According to FIG. 2a, the front view of the vehicle has a recessed bumper area having a number of spaced apart horizontal fins, thereby generating a vented effect. Moreover, the grill has a cross-hatched design. The headlights have a generally tear dropped shape.

According to FIG. 2b, the rear of the vehicle has an “I”-shaped design line running along the length of the rear bumper. The taillights are polygonal in shape and have generally outwardly tapered sides. The front and rear design features are distinct, thereby not portraying an overall design theme.

According to FIG. 2c, the front and rear edge contours are varied and do not carry through an overall design theme. From the belt line to the platform line, the front edge contour includes a tapered portion outlining the side of the headlight and an outwardly tapered portion, a vertically downwardly extending portion, and an inwardly tapered portion outlining the side of the front bumper. From the belt line to the platform line, the rear edge contour includes a vertically downwardly extending portion outlining the side of the tailgate, and an outwardly tapered portion, a vertically downwardly extending portion, and an inwardly tapered portion outlining the side of the rear bumper. The vertically downwardly extending portion of the rear edge contour is longer than that of the front bumper.

In light of the foregoing, what is needed is an exterior vehicle architecture having tandem design cues on the front and rear ends of the vehicle to produce a strengthened design theme to drive increased brand recognition. What is also needed is a method of designing a vehicle exterior architecture with front and rear ends having tandem design cues.

### SUMMARY OF THE INVENTION

One aspect of the present invention is an exterior vehicle architecture having tandem design cues on the front and rear ends of the vehicle to produce a strengthened design theme to drive increased brand recognition. Another aspect of the present invention is a method of designing a vehicle exterior architecture having tandem design cues.

According to a first embodiment of the present invention, a vehicle architecture is disclosed. The vehicle exterior includes a front end and a rear end. The front end has one or more front end design cues. The rear end has one or more rear end design cues. One of the front and rear end design cues have commonality to produce a common design cue to reinforce the brand identify of the vehicle. The common design cue extends substantially through two or more components of the vehicle front and rear ends.

In certain applications, the two or more components of the front end are a pair of headlights and a grille and the two or more components of the rear end are a pair of taillights and a gate.

The common design cue can be a design configuration located on the front and rear ends of the vehicle. The design configuration can substantially extend to the left and right sides of the front and rear ends of the vehicle. The design configuration can be symmetrical about an axis substantially parallel to the vehicle platform. The design configuration can be symmetrical about an axis substantially parallel to the vehicle centerline. The design configuration can include one or more styling lines. The common design cue can be a color combination. The gate can be a tailgate or liftgate. The vehicle can be a minivan or other vehicle.

According to a second embodiment of the present invention, a method of designing a vehicle exterior architecture is disclosed. The method includes providing a vehicle having front and rear ends, designing the front and rear ends in tandem to produce a common design cue extending about the entire length of the vehicle front and rear. The common design cue reinforces the brand identity of the vehicle.

In certain applications, the method further includes designing a design configuration on the front and rear ends as the common design cue. The design configuration can include one or more styling lines. The method can further include designing a tandem styling line on at least one edge of each of the vehicle front and rear ends.

According to a third embodiment, an exterior vehicle architecture is disclosed. The architecture includes a vehicle front end, a vehicle rear end, and a common design cue included on the vehicle front and rear end extending about the entire length of the vehicle front and rear for reinforcing the brand identify of the vehicle.

The common design cue can be a design configuration. The design configuration can be a three bar configuration. The common design cue can be a color combination.

The above and other objects, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompany drawings which:

FIG. 1a is a front view of the 2005 GMC Safari minivan;

FIG. 1b is a rear view of the 2005 GMC Safari minivan;

FIG. 1c is a side view of the 2005 GMC Safari minivan;

FIG. 2a is a front view of the 2005 Toyota Sienna minivan;

FIG. 2b is a rear view of the 2005 Toyota Sierra minivan;

FIG. 2c is a side view of the 2005 Toyota Sierra minivan;

FIG. 3 is a fragmented, front perspective view of the 2005 Ford Fairlane minivan according to one embodiment of the present invention;

FIG. 4 is a fragmented, rear perspective view of the 2005 Ford Fairlane minivan according to one embodiment of the present invention; and

FIG. 5 is a fragmented, side perspective view of the 2005 Ford Fairlane minivan according to one embodiment of the present invention.

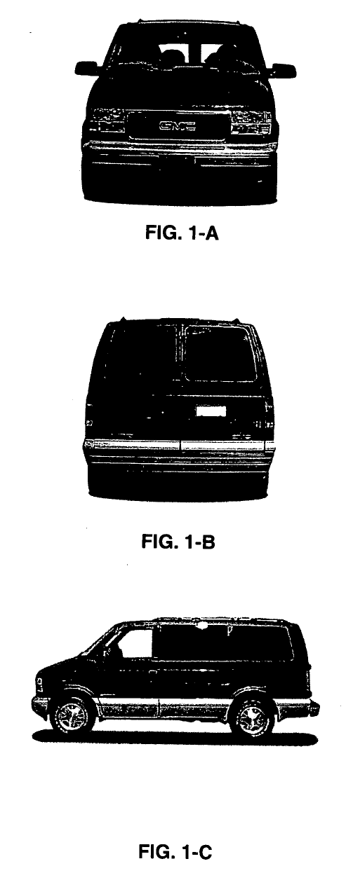

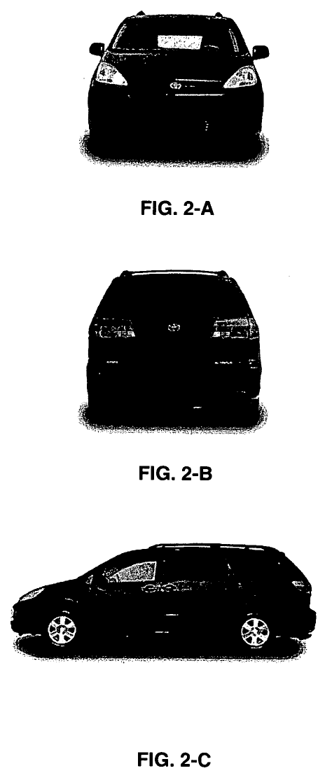

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of the invention that may be embodied in various and alternative forms. Therefore, specific functional details described herein are not to be interpreted as limiting, but merely as a representative basis for the claims and/or as a representative basis for teaching one of ordinary skill in the art to variously employ the present invention.

Except where otherwise expressly indicated, all numerical quantities in this description indicating architectural dimensions are to be understood as modified by the word “about” in describing the broadest scope of the invention. Practice within the numerical limits stated is generally preferred. Also, unless expressly stated to the contrary, the first definition of an acronym or other abbreviation applies to all subsequent uses herein of the same abbreviation and applies mutatis mutandis to normal grammatical variations of the initially defined abbreviation; and, unless expressly stated to the contrary measurement of a dimension is determined by the same technique as previously or later referenced for the same property.

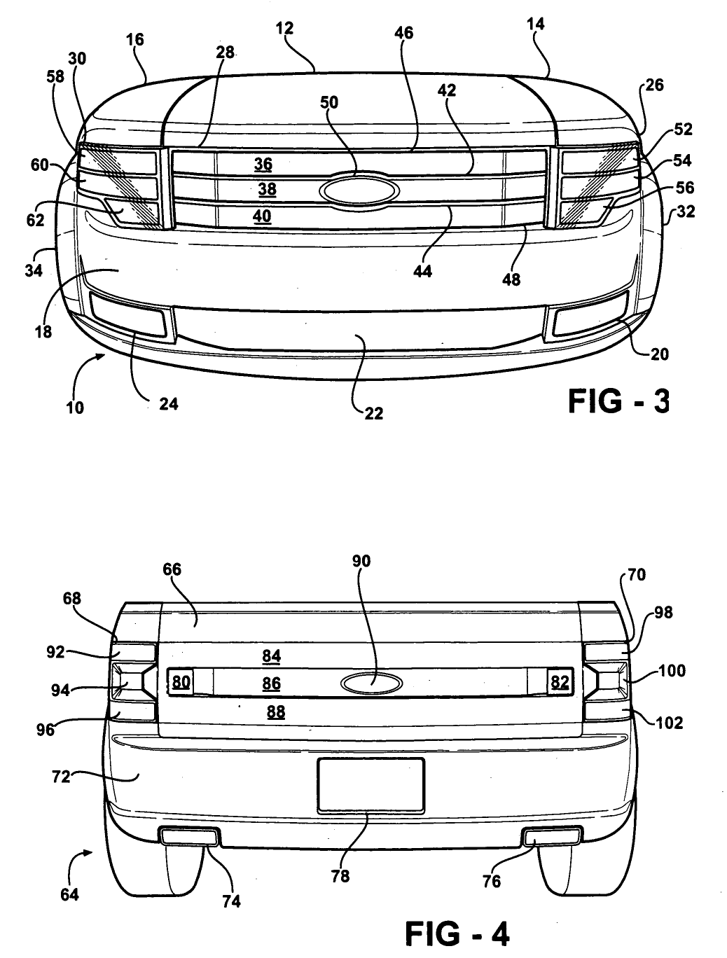

With reference to FIG. 3, a fragmented, front perspective view of the 2005 Ford Fairlane is shown. While describing the figures, it should be understood that the left side of the vehicle refers to the driver's side of the vehicle and the right side refers to the front passenger side of the vehicle. Front end 10 includes a number of components, including, but not limited to, hood 12, left front quarter panel 14, right front quarter panel 16, bumper 18, left vent 20, middle vent 22, right vent 24, left headlight 26, grille 28, and right headlight 30. Left front quarter panel 14 includes left wheel well 32 and right front quarter panel 16 includes right wheel well 34.

Grille 28 includes three horizontal bars extending towards headlights 26 and 30. The three horizontal bars, referred to herein as upper bar 36, middle bar 38, and lower bar 40, are spaced apart from each other to form spaces 42 and 44. Upper bar 36 is spaced apart from hood 12 to form space 46. Lower bar 40 is spaced apart from front bumper 18 to form space 48. Spaces 42, 44, 46 and 48 can be considered style lines. In certain embodiments, the widths of spaces 42, 44, 46 and 48 are about one-fourth the widths of bars 36, 38 and 40. Each bar includes a middle portion and a left and right inwardly tapered portion. In certain embodiments, the inwardly tapered portions are about equal in length and are about one-sixth the length of the middle portion. Emblem 50 can be affixed to the middle portion of one or more bars.

Left headlight 26 includes three horizontal and substantially parallel portions, i.e. left upper portion 52, left middle portion 54, and left lower portion 56. In certain embodiments, the lengths of portions 52 and 54 are substantially equal, and the length of lower portion 56 is less than the lengths of the other portions. Moreover, lower portion 56 can include a tapered side. The widths of each portion can be substantially equal to that of bars 36, 38 and 40. Portions 52, 54 and 56 can be bisected by lines, which can be considered style lines.

Right headlight 30 includes three horizontal and substantially parallel portions, i.e. right upper portion 58, right middle portion 60, and right lower portion 62. The lengths, widths, and proportions of the right portions can be substantially same as that of the left portions.

In certain embodiments, the overall shape of the left and right headlights 26 and 30 are mirror images of each other.

Left and right upper portions 52 and 58 and upper bar 36 have substantially the same vertical orientation to form an upper design feature. Left and right middle portions 54 and 60 and middle bar 38 have substantially the same vertical orientation to form a middle design feature. Left and right lower portions 56 and 62 and lower bar 40 have substantially the same vertical orientation to form a lower design feature. The combination of upper, middle and lower design features can be referred to as a three bar design configuration. In certain embodiments, the three bar design configuration extends the width of vehicle front end 10, towards wheel wells 32 and 34. This design configuration can be symmetrical about an axis substantially parallel to the vehicle platform, the axis being located along the middle of the width of middle bar 38. The three bar design configuration can also be symmetrical about an axis substantially parallel to the vehicle centerline.

Furthermore, left vent 20, middle vent 22 and right vent 24 have substantially the same vertical orientation to form a vented design feature. As with the three bar configuration, the vented design feature can extend the width of the vehicle front end 10, towards wheel wells 32 and 34.

With reference to FIG. 4, a fragmented, front perspective view of the 2005 Ford Fairlane is shown. Rear end 64 includes a number of components, including, but not limited to, tailgate 66, left taillight 68, right taillight 70, rear bumper 72, left exhaust opening 74, right exhaust opening 76, license plate mount 78, left tailgate latch 80, and right tailgate latch 82.

Tailgate 66 includes three horizontal bars, i.e. upper bar 84, middle bar 86, and lower bar 88. The lower boundary of upper bar 84 is adjacent to the upper boundary of middle bar 86. The upper boundary of lower bar 88 is adjacent to the lower boundary of middle bar 86. It should be understood that these boundaries can be considered style lines. In certain embodiments, upper and lower bars 84 and 88 extend to the left and right sides of tailgate 66. In certain embodiments, middle bar 86 extends proximate to the left and right sides of tailgate 66. Middle bar 86 can include left and right tailgate latches 80 and 82. A portion of middle bar 86 can be recessed relative to the surface of upper and lower bars 84 and 88. Emblem 90 can be affixed to middle bar 86.

Left taillight 68 includes three horizontal and substantially parallel portions, i.e. left upper portion 92, left middle portion 94, and left lower portion 96. Portions 52, 54 and 56 can be bisected by lines, which can be considered style lines. A plastic cover can be mounted to upper and lower portions 92 and 96. The light generated by the bulb of the taillight housing shines through the plastic covers. Middle portion 94 can include a recessed portion, which may also mount a plastic cover. Right taillight 70 includes horizontal and substantially parallel portions, i.e. right upper portion 98, right middle portion 100, and right lower portion 102. Portions 52, 54 and 56 can be bisected by lines, which can be considered style lines. As with the coordinating left portions, the right portions can likewise mount plastic covers for diffracting light emanating from a light bulb mounted in the taillight housing.

In certain embodiments, the overall shape of the left and right taillights 68 and 70 are mirror images of each other.

Left and right upper portions 92 and 98 and upper bar 84 have substantially the same vertical orientation to form an upper design feature. Left and right middle portions 94 and 100 and middle bar 86 have substantially the same vertical orientation to form a middle design feature. Left and right lower portions 96 ans 102 and lower bar 88 have substantially the same vertical orientation to form a lower design feature. The combinations of upper, middle and lower design features can be referred to as a three bar design configuration. In certain embodiments, the three bar design configuration extend the width of vehicle rear end 64 towards the left and right sides of vehicle rear end 64. This design configuration can be symmetrical about an axis substantially parallel to the vehicle platform, the axis being located along the middle of the width of middle bar 86. The three bar design configuration can also be symmetrical about an axis substantially parallel to the vehicle centerline.

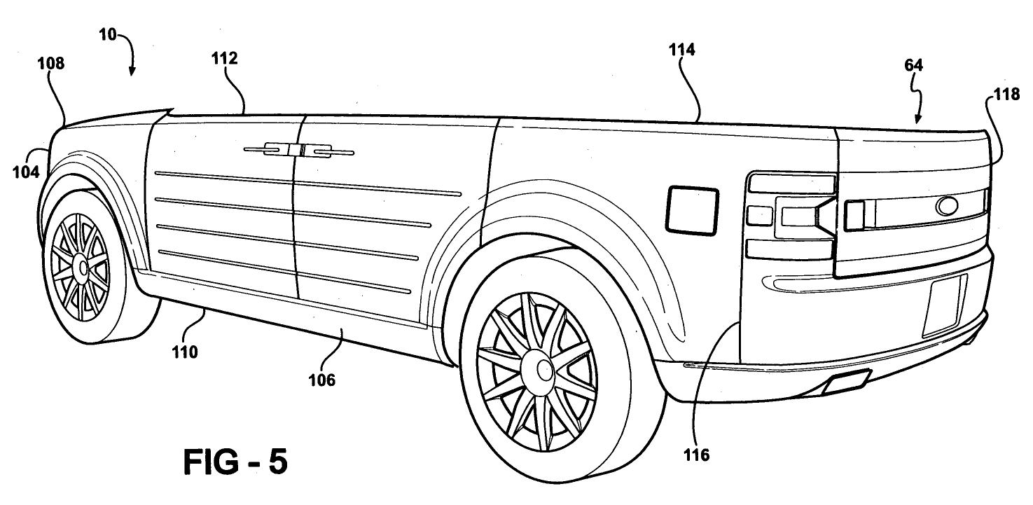

With reference to FIG. 5, a fragmented, perspective side view of the 2005 Ford Fairlane is shown. According to FIG. 5, left front edge contour 104 is defined by the intersection of vehicle left side 106 and vehicle front end 10. In certain embodiments, left front edge contour 104 extends to belt line 108 and platform line 110. Right front edge contour 112 is defined by the intersection of vehicle right side 114 and front end 10. In certain embodiments, edge contour 112 extends to belt line 108 and platform line 110. Left rear edge contour 116 is defined by the intersection of vehicle left side 106 and rear end 64. Right rear edge contour 118 is defined by the intersection of vehicle right side 114 and rear end 64. The rear edge contours 116 and 118 can extend to belt line 108 and platform line 110. In certain embodiments, front edge contour 104 is symmetrical to rear edge contours 116 about axis that intersects vehicle side 106 and is perpendicular to vehicle platform 110. Moreover, front edge contour 106 can be symmetrical to rear edge contours 118 about an axis that intersects vehicle side 114 and is perpendicular to vehicle platform 110. It should be understood that the edge contours can be considered design lines.

According to certain embodiments of the present invention, the three bar design configuration can be the common design cue. Moreover, symmetrical edge contours on the front and rear ends of the vehicle can serve as the common design cue. Beneficially, the common design cue reinforces the brand identity of the vehicle, and may increase revenues of the vehicle and market share for the vehicle manufacturer.

While the best mode for carrying out the invention has been described in detail, those familiar with the art to which this invention relates will recognize various alternative designs and embodiments for practicing the invention as defined by the following claims. For example, although FIGS. 3 through 5 depict the invention embodied as part of a minivan, other motor vehicles can be used along with the teachings of the present invention, for example, pickup trucks and sedans.

1. A vehicle architecture comprising:
a vehicle exterior including a front end and a rear end,
the front end having one or more front end design cues,
the rear end having one or more rear end design cues,
one of the front and rear end design cues having commonality to produce a common design cue to reinforce the brand identity of the vehicle, and
the common design cue extending substantially through two or more components of the vehicle front and rear ends and extending about the entire length of the vehicle front and rear ends.

2. The vehicle architecture of claim 1 wherein the two or more components of the front end are a pair of headlights and a grille and the two or more components of the rear end are a pair of taillights and a gate.

3. The vehicle architecture of claim 1 wherein the common design cue is a design configuration located on the front and rear ends.

4. The vehicle architecture of claim 1 wherein the design configuration substantially extends to the left and right sides of the front and rear ends.

5. The vehicle architecture of claim 1 wherein the design configuration is symmetrical about a plane substantially parallel to the vehicle platform.

6. The vehicle architecture of claim 1 wherein the design configuration is symmetrical about a plane substantially parallel to the vehicle centerline.

7. The vehicle architecture of claim 3 wherein the design configuration includes one or more styling lines.

8. The vehicle architecture of claim 1 wherein the common design cue is a color combination.

9. The vehicle architecture of claim 2 wherein the gate is a tailgate.

10. The vehicle architecture of claim 2 wherein the gate is a liftgate.

11. The vehicle architecture of claim 1 wherein the vehicle is a minivan.

12. The vehicle architecture of claim 1 wherein the vehicle is a passenger car.

13. A method of designing a vehicle exterior architecture, the method comprising:
providing a vehicle having front and rear ends;
designing the front and rear ends in tandem to produce a common design cue extending about the entire length of the vehicle front and rear,
whereby the common design cue reinforces the brand identity of the vehicle.

14. The method of claim 13 further comprising designing a design configuration on the front and rear ends as the common design cue.

15. The method of claim 14 wherein the design configuration includes one or more styling lines.

16. The method of claim 14 further comprising designing a tandem styling line on at least one edge of each of the vehicle front and rear ends.

17. An exterior vehicle architecture comprising:
a vehicle front end;
a vehicle rear end; and
a common design cue included on the vehicle front and rear end extending about the entire length of the vehicle front and rear for reinforcing the brand identity of the vehicle.

18. The exterior vehicle architecture of claim 17, wherein the common design cue is a design configuration.

19. The exterior vehicle architecture of claim 17, wherein the design configuration is a three bar configuration.

20. The exterior vehicle architecture of claim 17, wherein the common design cue is a color combination.
